(19) United States
(12) Patent Application Publication
(10) Pub. No.: US 2015/0318639 A1
(43) Pub. Date: Nov. 5, 2015

(54) LEVER-TYPE CONNECTOR

(71) Applicant: SUMITOMO WIRING SYSTEMS, LTD., Mie (JP)

(72) Inventors: Teruo Hara, Yokkaichi, Mie (JP); Naotaka Tanikawa, Yokkaichi, Mie (JP)

(73) Assignee: Sumitomo Wiring Systems, Ltd., Yokkaichi, Mie (JP)

(21) Appl. No.: 14/758,813

(22) PCT Filed: Aug. 28, 2013
(86) PCT No.: PCT/JP1203/072962

§ 371 Date: Jul. 1, 2015

(30) Foreign Application Priority Data
Jan. 25, 2013 (JP) 2013-011703

(51) Int. Cl. H01R 13/629

(52) U.S. Cl. CPC H01R 13/62977

(57) ABSTRACT

A lever-type connector of the present invention includes a female housing (11), a lever (30) rotatably mounted on the female housing (11) and rotatable between an initial position and a connection position, a male housing (51) including a connector fitting portion (53) into which the female housing (11) is fittable and a lever fitting portion (54) into which the lever (30) is fittable, both the connector fitting portion (53) and the lever fitting portion (54) being open in the same direction, and a lock projection (56) provided in the lever fitting portion (54) and configured to hold the lever (30) fitted into the lever fitting portion (54) at the connection position.

### BACKGROUND

1. Field of the Invention

The present invention relates to a lever-type connector.

2. Description of the Related Art

Conventionally, a lever-type connector in which both male and female connectors are connected and separated by rotating a lever is, for example, known from the following Japanese Unexamined Patent Publication No. 2008-226827. The female connector includes a female housing, a rear holder mounted on a rear side of the female housing and a rear cover mounted behind the rear holder and the lever is rotatably mounted on the rear holder. The lever is rotatable between an initial position and a connection position. When the lever is rotated from the initial position to the connection position after both male and female housings are lightly connected with the lever located at the initial position, the both male and female connectors are connected. When the lever reaches the connection position, a locking portion provided on the lever is locked to a projection provided on the rear cover, whereby the lever is held at the connection position.

However, in the above lever-type connector, the rear holder on which the lever is mounted needs to be prepared and the connector is enlarged as a whole. Further, since a lock mechanism for holding the lever at the connection position is provided on the rear cover, not only the rear holder, but also the rear cover has to be prepared. Furthermore, since a wire draw-out direction is limited to a certain direction if the rear cover is provided, the handling of wires drawn out from the connector is difficult depending on a mounted position of the connector.

The present invention was completed in view of the above situation and aims to miniaturize an entire connector by eliminating a rear cover and facilitate the handling of wires.

### SUMMARY OF THE INVENTION

The present invention is directed to a lever-type connector, including a female housing, a lever rotatably mounted on the female housing and rotatable between an initial position and a connection position, a male housing including a connector fitting portion into which the female housing is fittable and a lever fitting portion into which the lever is fittable, both the connector fitting portion and the lever fitting portion being open in the same direction, and a lock portion provided in the lever fitting portion and configured to hold the lever fitted into the lever fitting portion at the connection position.

According to such a configuration, the enlargement of the female housing can be avoided since the lock portion is provided not in the female housing, but in the lever fitting portion of the male housing. Further, it is not necessary to provide a rear cover and a rear holder as before and the entire connector can be miniaturized since the lever is mounted on the female housing. Furthermore, the handling of wires can be facilitated since the rear cover is not provided.

The following configurations are preferable as embodiments of the present invention.

The lever may be configured into a substantially gate shape by including a pair of cam plates each formed with a cam groove and an operating portion coupling the cam plates, the male housing may include a plurality of the connector fitting portions arranged side by side, and the pair of cam plates may be respectively rotatably mounted on a pair of outer surfaces extending in an arrangement direction of the connector fitting portions out of an outer peripheral surface of the female housing.

According to such a configuration, the female housings can be more closely arranged since the cam plates are mounted on the pair of outer surfaces extending in the arrangement direction of the connector fitting portions out of the outer peripheral surface of the female housing, i.e. on the surfaces different from the surface located between adjacent female housings. Associated with this, the male housing can be miniaturized in the arrangement direction of the connector fitting portions. Thus, the entire connector can be miniaturized in the arrangement direction of the connector fitting portions.

Only one lever fitting portion may be provided for one connector fitting portion and arranged on an outer surface extending in the arrangement direction of the connector fitting portion out of an outer peripheral surface of the connector fitting portion.

According to such a configuration, adjacent connector fitting portions can be more closely arranged and the male housing can be miniaturized in the arrangement direction of the connector fitting portions since the lever fitting portion is not arranged between the adjacent connector fitting portions.

A cam plate fitting portion fittable to a peripheral edge part of the cam plate between the initial position and the connection position may be provided on an outer surface opposite to the lever fitting portion out of the outer peripheral surface of the connector fitting portion.

According to such a configuration, the detachment of the cam plate from the female housing during a rotating operation of the lever can be prevented by fitting the peripheral edge part of the cam plate into the cam plate fitting portion.

The operating portion may be arranged on a side edge opposite to the adjacent female housing when the lever is at the connection position for a pair of the female housings located at opposite ends in an arrangement direction out of a plurality of the female housings.

According to such a configuration, adjacent female housings can be more closely arranged since the operating portion of the lever is not arranged between the adjacent female housings.

Wires drawn out from the female housing may not be bent in a direction different from a draw-out direction of the wires by the operating portion at the initial position.

According to such a configuration, the bending of the wires by the operating portion can be avoided when the lever is at the initial position.

The lever may include a locking piece configured to suppress the rotation of the lever from the initial position to the connection position and a lift preventing portion configured to prevent the locking piece from being lifted, the female housing may include a locking piece receiving portion configured to hold the lever at the initial position by being locked to the locking piece, and the locking piece may be deflected and deformed and arranged to overlap the lift preventing portion while maintaining a locked state to the locking piece receiving portion, whereby the lift of the locking piece is prevented and the locked state to the locking piece receiving portion is maintained, when the lever is pushed from the initial position to the connection position.

Normally, when a lever at an initial position is pushed to a connection position, a locking piece is locked to a locking piece receiving portion to hold the lever at the initial position. However, if the lever is pushed with a stronger force, a locked state of the locking piece and the locking piece receiving portion may be released to permit the rotation of the lever. In that respect, according to the above configuration, the locking piece is arranged to overlap the lift preventing portion upon being deflected and deformed and the lift of the locking piece is prevented by the lift preventing portion. Thus, the locked state of the locking piece and the locking piece receiving portion is maintained and the rotation of the lever at the initial position to the connection position can be reliably suppressed.

The lever may be configured into a substantially gate shape by including a pair of cam plates each formed with a cam groove and an operating portion coupling the cam plates, and the locking piece may be formed in a cantilever manner along a side edge part of the cam plate.

According to such a configuration, the locking piece can be arranged at a position as distant from a center of rotation of the lever as possible. Thus, when the lever is pushed, a force applied to a locked part of the locking piece and the locking piece receiving portion can be reduced and the locking piece is more easily deflected and deformed with the locked state of the locking piece and the locking piece receiving portion maintained.

The female housing may include a seal ring fitted on an outer peripheral surface and a receptacle formed to cover the seal ring and be open forward, and the locking piece receiving portion may be formed by cutting an opening edge of the receptacle.

According to such a configuration, the locking piece receiving portion can be formed on the receptacle and needs not be provided separately from the receptacle.

According to the present invention, it is possible to miniaturize an entire connector by eliminating a rear cover and facilitate the handling of wires.

### BRIEF DESCRIPTION OF THE DRAWINGS

FIG. 1 is a perspective view of a lever-type connector in a first embodiment.

FIG. 2 is a plan view showing a state where female housings are lightly fitted in connector fitting portions.

FIG. 3 is a plan view showing a state where the female housings are fitted to the backs of the connector fitting portions.

FIG. 4 is a section along A-A of FIG. 2.

FIG. 5 is a section along B-B of FIG. 3.

FIG. 6 is a section showing a state where a lever is rotatably mounted on the female housing.

FIG. 7 is a section showing a state where cam pins are located at the entrances of cam grooves.

FIG. 8 is a section showing a state where the cam pins are located at back ends of the cam grooves and connection is completed.

FIG. 9 is a perspective view of a male housing viewed obliquely from front,

FIG. 10 is a perspective view of the male housing viewed obliquely from behind.

FIG. 11 is a front view of the male housing.

FIG. 12 is a bottom view of the male housing.

FIG. 13 is a section along C-C of FIG. 11.

FIG. 14 is a section along D-D of FIG. 11.

FIG. 15 is a perspective view of the female housing alone.

FIG. 16 is a perspective view of the lever viewed from a side opposite to an operating portion.

FIG. 17 is a perspective view of the lever viewed from the side of the operating portion.

FIG. 18 is a perspective view of a female connector showing a state where a lever is at an initial position in a second embodiment.

FIG. 19 is a perspective view of the female connector showing a state where the lever at the initial position is deflected and deformed by being pushed to a connection position.

FIG. 20 is a plan view of the female connector showing a state where the lever is at the initial position.

FIG. 21 is a plan view of the female connector showing the state where the lever at the initial position is deflected and deformed by being pushed to the connection position.

FIG. 22 is a side view of the female connector showing the state where the lever is at the initial position.

FIG. 23 is a section along E-E of FIG. 22.

FIG. 24 is a perspective view in section showing a locked state of locking pieces and locking piece receiving portions.

FIG. 25 is a front view of a male connector.

FIG. 26 is a section showing a state before the male connector and the female connector are connected.

FIG. 27 is a section showing a state where the male connector and the female connector are lightly connected.

FIG. 28 is a section showing a state where the locking pieces are lifted by releasing ribs to be released from the locked state to the locking piece receiving portions.

FIG. 29 is a section showing a state where the male connector and the female connector are connected.

FIG. 30 is a perspective view of the lever.

FIG. 31 is a side view of the lever.

FIG. 32 is a plan view of the lever.

FIG. 33 is a bottom view of the lever.

FIG. 34 is a perspective view of a female housing.

### DETAILED DESCRIPTION

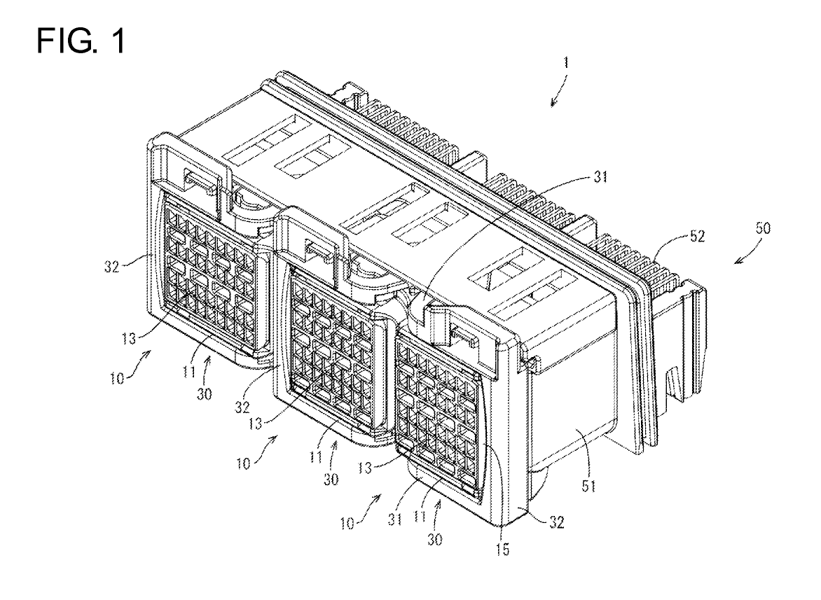

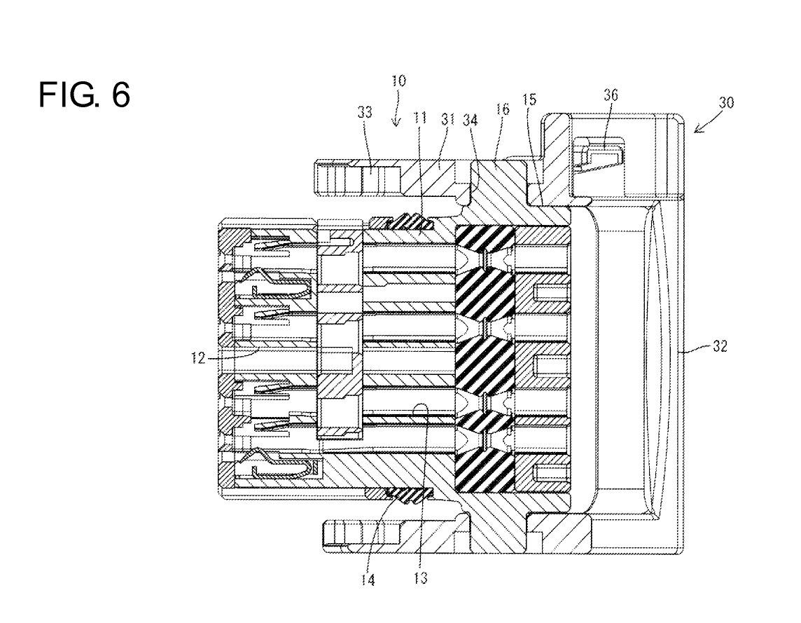

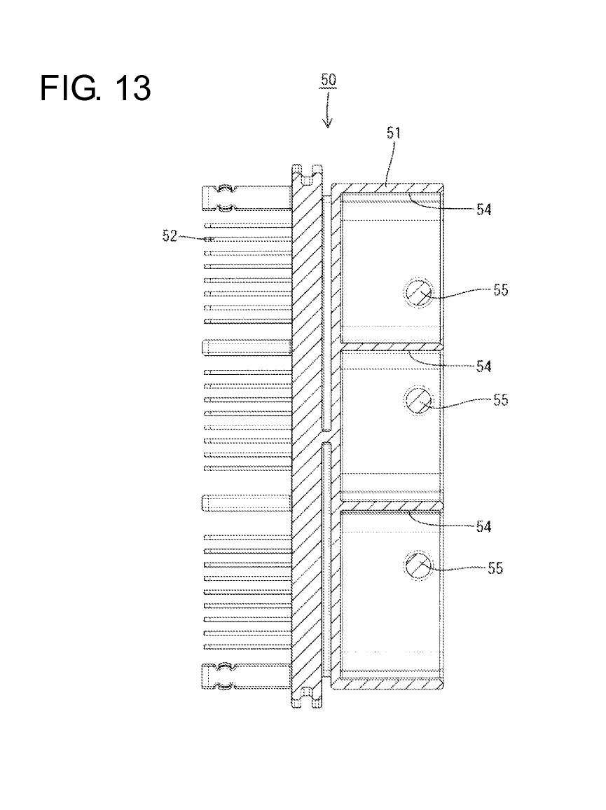

A first embodiment of the present invention is described with reference to FIGS. 1 to 17. A lever-type connector in this embodiment includes, as shown in FIG. 1, a plurality of female connectors 10 and a male connector 50 to which these female connectors 10 are connectable. A lever 30 is rotatably mounted on each female connector 10, and each female connector 10 is individually connectable to and separable from the male connector 50 by rotating this lever 30. In the following description, a connecting direction of the female connectors 10 to the male connector 50 is referred to as a front-back direction and connection surface sides of the female connectors 10 and the male connector 50 are referred to as front sides.

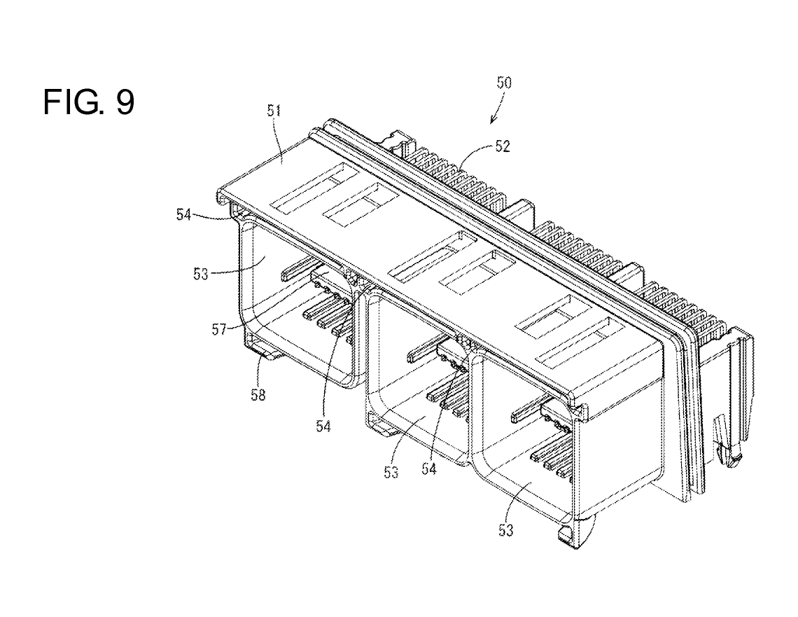

First, the configuration of the male connector 50 is described. As shown in FIG. 9, the male connector 50 includes a male housing 51 made of synthetic resin and long in a width direction and a plurality of male terminals 52 held in this male housing 51. The male terminal 52 is formed by bending a square wire made of an electrically conductive metal into an L shape. On the other hand, the male housing 51 is made of synthetic resin and includes a plurality of connector fitting portions 53 into which the female connectors 10 are fittable. Any of the plurality of connector fitting portions 53 is open forward and the connector fitting portions 53 are arranged side by side in the width direction.

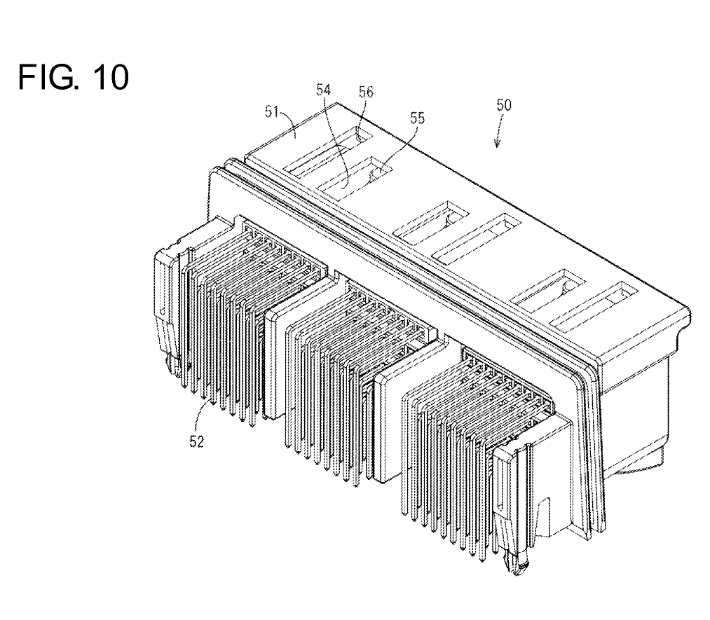

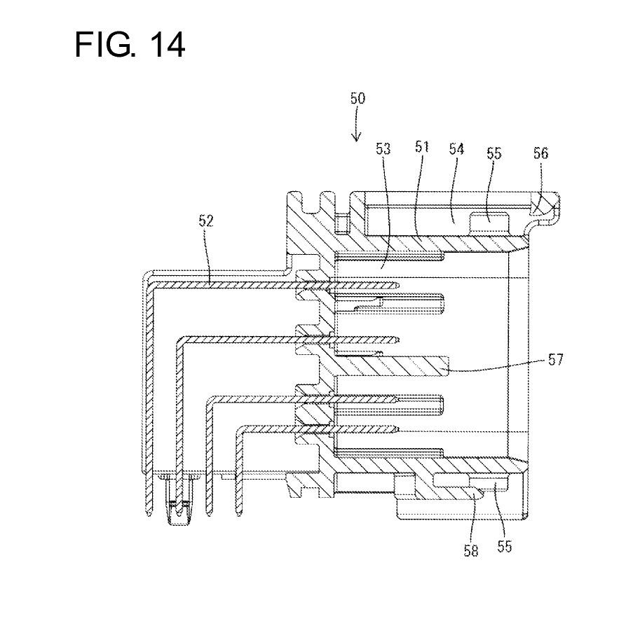

One end of the male terminal 52 projects forward from the back wall of the connector fitting portion 53 as shown in FIG. 14 and the other end thereof is bent at a right angle to extend downward after extending backward through the back wall of the connector fitting portion 53 as shown in FIG. 10. Specifically, the male connector 50 is a board connector to be mounted on a circuit board (not shown) and the other ends of the male terminals 52 are inserted into through holes (not shown) formed on the circuit board and soldered.

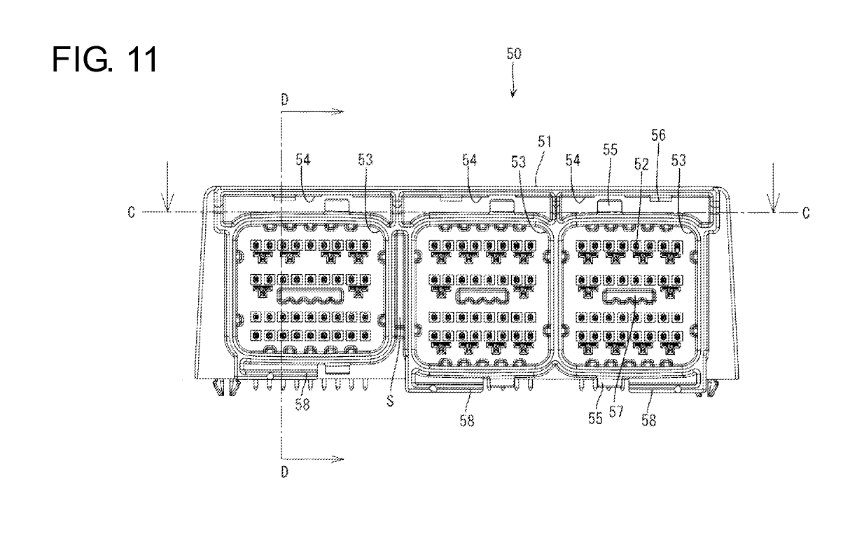

As shown in FIG. 11, lever fitting portions 54 into which the levers 30 are fittable are arranged on the upper surfaces (surfaces extending along an arrangement direction of the connector fitting portions 53) of the connector fitting portions 53. The lever fitting portions 54 are open forward and a plurality of lever fitting portions 54 are provided to correspond to the respective connector fitting portions 53. A cam pin 55 is formed to project upward on the lower surface in the lever fitting portion 54 (upper surface of the connector fitting portion 53). Further, a cam pin 55 is formed to project downward also on the lower surface of the connector fitting portion 53. A pair of upper and lower cam pins 55 are coaxially arranged.

A lock projection 56 is formed to project downward on the upper surface in the lever fitting portion 54. As shown in FIG. 14, the lock projection 56 is arranged on an opening edge part of the lever fitting portion 54 and the cam pin 55 is arranged somewhat at the back side of the lock projection 56. A mold removal hole for forming the rear surface of the lock projection 56 is formed behind the lock projection 56 and open upward.

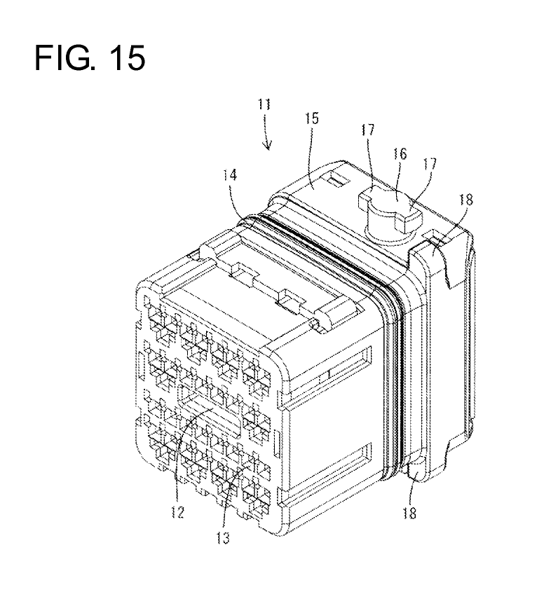

As shown in FIG. 11, a plate-like guide projection 57 is provided in a central part of the connector fitting portion 53. This guide projection 57 is formed to project forward from the back wall of the connector fitting portion 53. On the other hand, a guide recess 12 into which the guide projection 57 is fittable is formed on the front surface of the female connector 10 as shown in FIG. 15. When the female connector 10 is fitted into the connector fitting portion 53, the guide projection 57 is fitted into the guide recess 12, whereby a connecting operation of the female connector 10 and the male connector 50 is guided and smoothly performed.

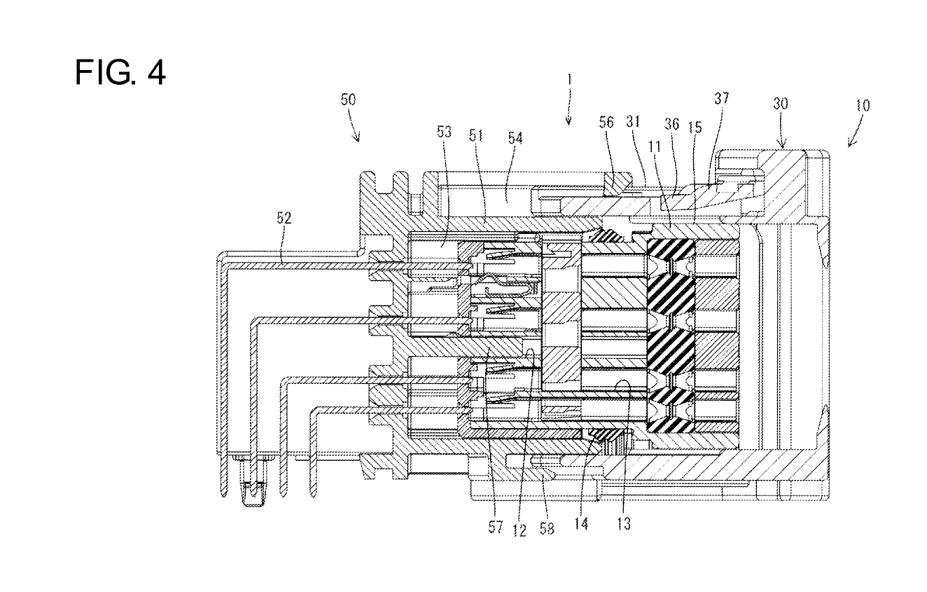

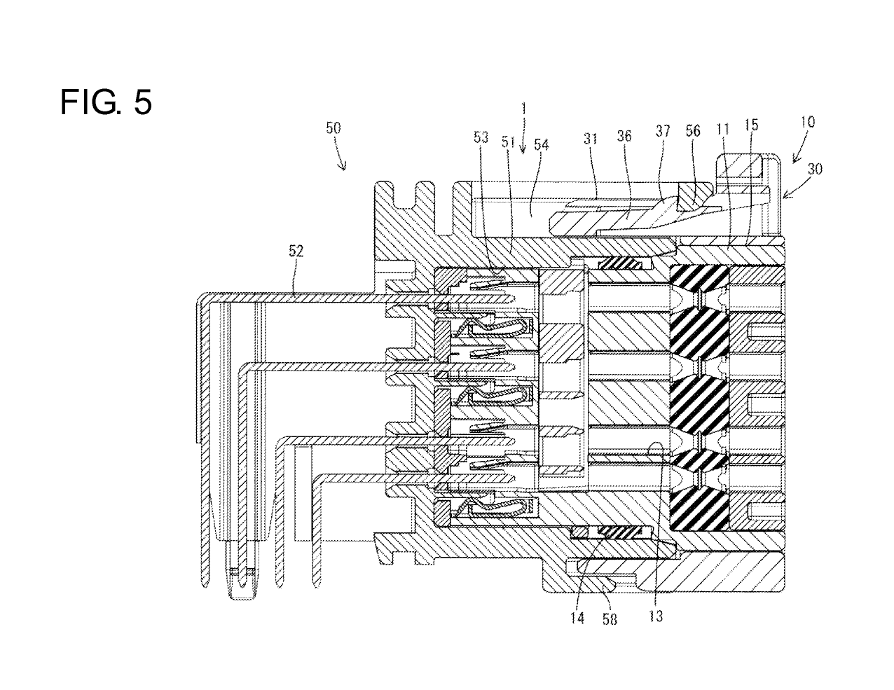

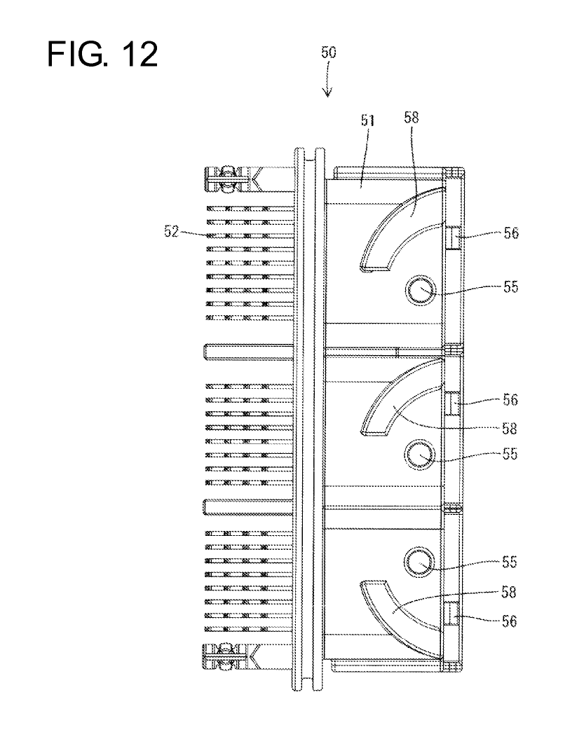

As shown in FIG. 12, cam plate fitting portions 58 into which peripheral edge parts of cam plates 31 to be described later are fittable are provided on the lower surface of the male housing 51. When the female connector 10 and the male connector 50 are lightly connected, the peripheral edge part of the cam plate 31 is fitted into this cam plate fitting portion 58 and a state of the cam plate fitting portion 58 fitted to the peripheral edge part of the cam plate 31 is maintained between an initial position shown in FIG. 4 and a connection position shown in FIG. 5. In this way, it can be avoided that the cam plate 31 is separated from the male housing 51 and the lever 30 is opened and deformed.

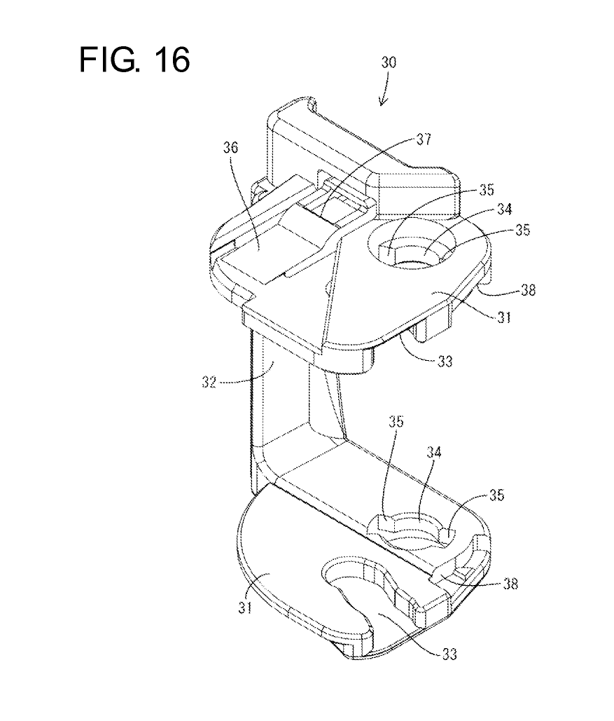

Next, the configuration of the female connector 10 is described. The female connector 10 is formed by assembling the lever 30 shown in FIG. 16 with a female housing 11 shown in FIG. 15. The female housing 11 is made of synthetic resin and substantially in the form of a rectangular block. Cavities 13 penetrating in the front-back direction are formed in the female housing 11. Unillustrated female terminals can be accommodated into the cavities 13 and the male terminals 52 are fitted and connected to the female terminals as the female connector 10 and the male connector 50 are connected.

As shown in FIG. 15, a seal ring 14 having a substantially rectangular shape is fitted on the outer peripheral surface of the female housing 11. When the female connector 10 and the male connector 50 are connected, the seal ring 14 is sandwiched between the outer peripheral surface of the female housing 11 and the inner peripheral surface of the connector fitting portion 53. In this way, the interior of the connector fitting portion 53 is held in a sealed state.

A lever mounting portion 15 on which the lever 30 is to be mounted is formed behind the seal ring 14 on the female housing 11. A supporting shaft 16 projects on each of upper and lower surfaces (surfaces extending in an arrangement direction of the plurality of female connectors 10) of the lever mounting portion 15. A pair of holding projections 17 are formed to bulge out in opposite directions on opposite radial end parts of a projecting end of the supporting shaft 16.

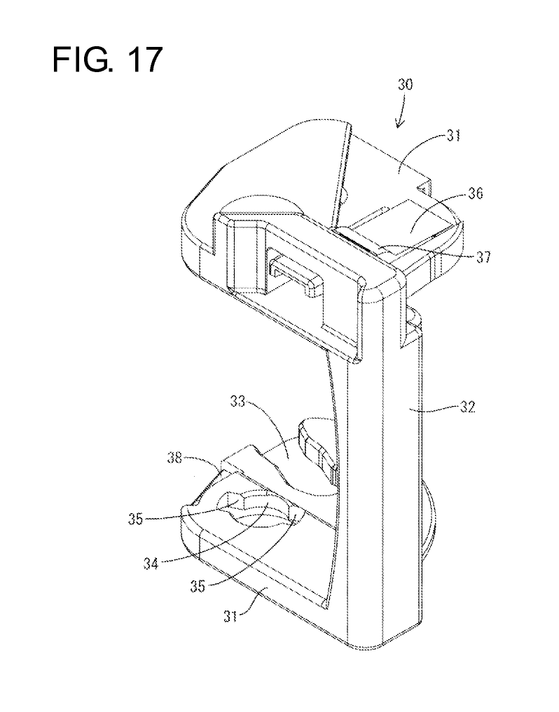

As shown in FIG. 17, the lever 30 is configured into a substantially gate shape by including a pair of cam plates 31 each formed with a cam groove 33 and an operating portion 32 coupling these cam plates 31. As shown in FIG. 16, the cam plate 31 is formed with a shaft hole 34, into which the supporting shaft 16 of the female housing 11 is fittable and which penetrates in a plate thickness direction. The shaft hole 34 is configured as a stepped round hole having a larger diameter on an upper side and mounting grooves 35, through which the holding projections 17 of the supporting shaft 16 are insertable, are respectively formed on opposite radial end parts of a lower side of the shaft hole 34. In assembling the lever 30 with the female housing 11, the lever 30 is slightly rotated after the supporting shafts 16 are fitted into the shaft holes 34 by passing each holding projection 17 through the mounting groove 35. In this way, each holding projection 17 is locked to a hole edge part of the shaft hole 34 in an axial direction to prevent the opening of the lever 30 and rotatably support the lever 30.

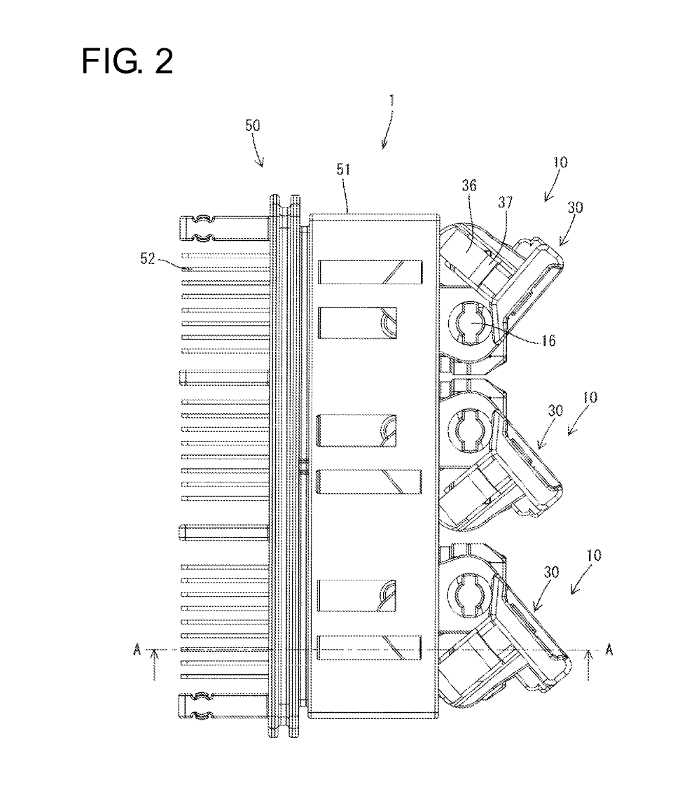

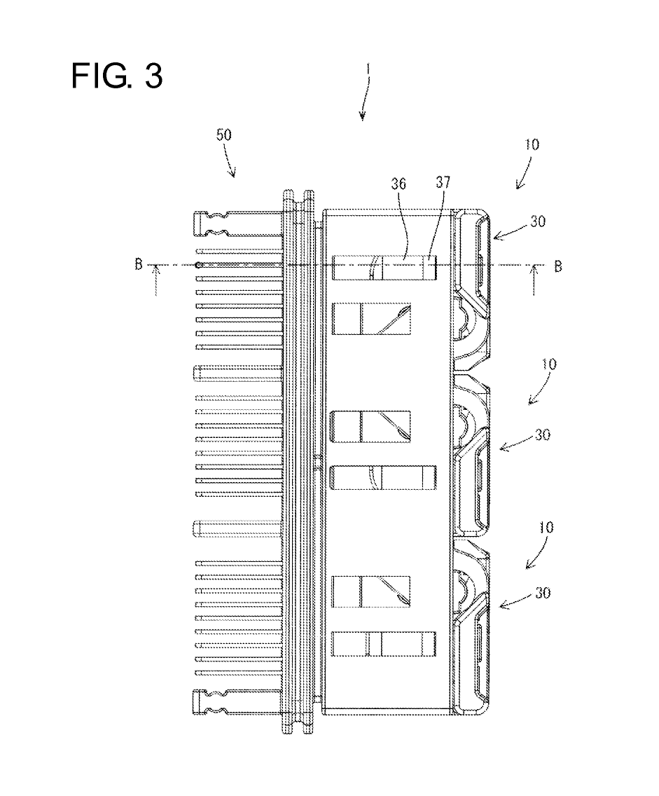

The lever 30 is rotatable between the initial position shown in FIG. 2 and the connection position shown in FIG. 3. The initial position is a position where wires (not shown) drawn out from the female housing 11 are not bent in a direction different from a draw-out direction of the wires by the operating portion 32. Thus, the wires drawn out backward from the female housing 11 are directly guided to a rear side without being laterally bent by the operating portion 32.

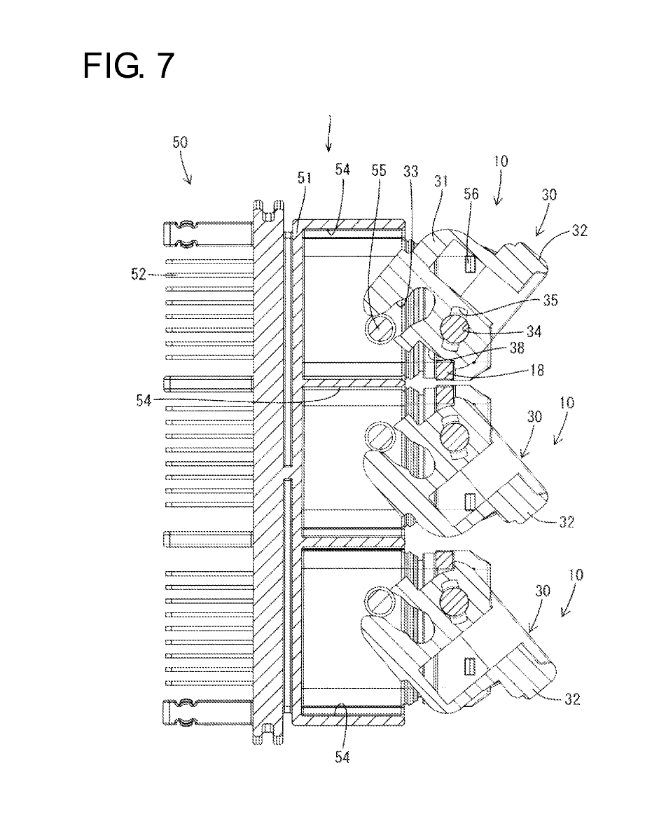

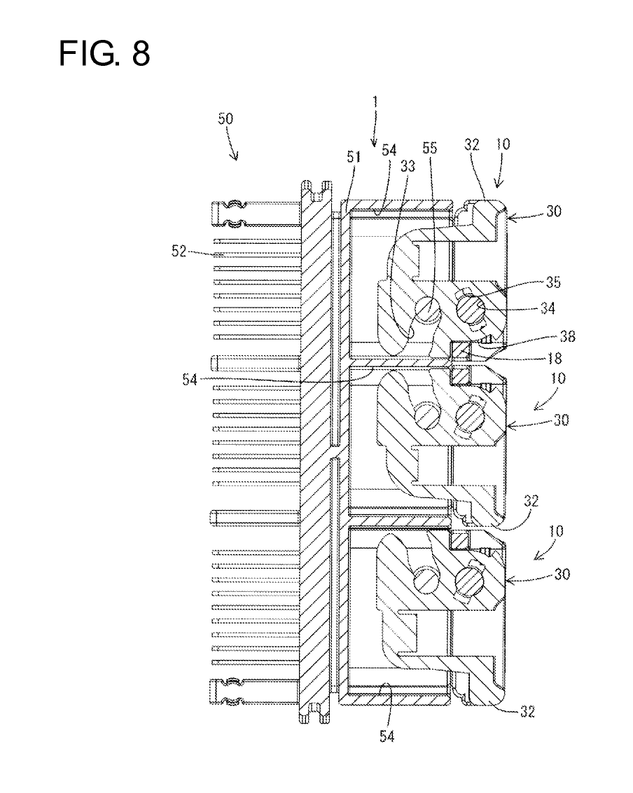

As shown in FIGS. 7, 8 and 16, regulation grooves 38 into which regulation projections 18 formed on opposite upper and lower surfaces of the female housing 11 can be accommodated are formed on the peripheral edges of the cam plates 31. One end of the regulation groove 38 is locked to the regulation projection 18 at the initial position, thereby suppressing backward (direction opposite to that toward the connection position) rotation of the lever 30 beyond the initial position. As shown in FIG. 8, the other end of the regulation groove 38 is locked to the regulation projection 18 at the connection position, thereby suppressing forward rotation (direction opposite to that toward the initial position) of the lever 30 beyond the connection position.

At the initial position, as shown in FIG. 7, the entrances of the cam grooves 33 are facing forward and the cam pins 55 can be guided into the cam grooves 33 through the entrances. The cam groove 33 is linearly formed to approach the shaft hole 34 from the outer edge of the cam plate 31. Thus, when the lever 30 is rotated from the initial position toward the connection position, the cam pins 55 move along the cam grooves 33 and the female connector 10 and the male connector 50 are pulled toward each other by a cam action based on the engagement of these. When the lever 30 reaches the connection position as shown in FIG. 8, the cam pins 55 reach the back ends of the cam grooves 33 and the female connector 10 and the male connector 50 are properly connected.

When the lever 30 is at the connection position as shown in FIG. 1, it is arranged along the lever mounting portion 15 of the female housing 11. At this time, the rear end position of the lever 30 is substantially aligned with the rear end position of the female housing 11 and the rear surface of the lever 30 constitutes a part of the rear surface of the female connector 10. Further, the cam plates 31 are arranged proximately to the upper and lower surfaces of the lever mounting portion 15 and the operating portion 32 of the right lever 30 in FIG. 1 is arranged proximately to the right side surface of the lever mounting portion 15. On the other hand, the operating portions 32 of the left and center levers 30 in FIG. 1 are arranged proximately to the left side surfaces of the lever mounting portions 15. Thus, as shown in FIG. 11, a space S for accommodating the operating portion 32 of the lever 30 is secured between the left connector fitting portion 53 and the center connector fitting portion 53 as shown in FIG. 11.

Contrary to this, since the operating portion 32 of the lever 30 needs not be accommodated between the center and right connector fitting portions 53, the adjacent connector fitting portions 53 are more closely arranged and inner spaces of the connector fitting portions 53 are partitioned by a common partition wall formed by one plate. As just described, the operating portions 32 of a pair of female housings 11 located on opposite left and right ends out of the plurality of female housings 11 are respectively arranged on outermost side edges when the levers 30 are at the connection position. Thus, the male connector 50 can be miniaturized in the width direction.

As shown in FIG. 16, the cam plate 31 is formed with a lock arm 36. This lock arm 36 is in the form of a cantilever and formed to be deflectable in a plate thickness direction of the cam plate 31. A locking portion 37 is formed on a longitudinal central part of the lock arm 36. This locking portion 37 is locked to the lock projection 56 of the lever fitting portion 54 in a connecting direction by connecting the female connector 10 and the male connector 50. In this way, the lever 30 is held at the connection position.

The first embodiment is configured as described above. Next, functions of this embodiment are described. To connect the female connector 10 and the male connector 50, the female housing 11 is fitted into the connector fitting portion 53 while the lever 30 is located at the initial position. Then, as shown in FIG. 7, the cam pins 55 enter the entrances of the cam grooves 33. When the lever 30 is rotated from the initial position to the connection position by pushing the operating portion 32 forward, the cam pins 55 and the inner walls of the cam grooves 33 are engaged with each other and the female connector 10 and the male connector 50 are pulled toward each other. During this time, a locking portion 37 of the lock arm 36 is engaged with the locking projections 56, whereby the lock arm 36 is deflected and deformed. When the locking portion 37 passes over the locking projection 56, the lock arm 36 resiliently returns. In this way, the locking portion 37 and the locking projection 56 are locked to hold the lever 30 at the connection position.

As described above, since the locking projection 56 is provided not in the female housing 11, but in the lever fitting portion 54 of the lever fitting portion 54 of the male housing 51 in this first embodiment, the enlargement of the female housing 11 can be avoided. Further, since the lever 30 is mounted on the female housing 11, it is not necessary to provide a rear cover and a rear holder as before and the entire connector can be miniaturized. Furthermore, since the rear cover is not provided, the handling of the wires can be facilitated.

Further, the lever 30 may be configured into a substantially gate shape by including the pair of cam plates 31 each formed with the cam groove 33 and the operating portion 32 coupling these cam plates 31, the male housing 51 may be such that the plurality of connector fitting portions 53 are arranged side by side and the pair of cam plates 31 may be respectively rotatably mounted on a pair of outer surfaces extending in the arrangement direction of the connector fitting portions 53 out of the outer peripheral surface of the female housing 11. According to such a configuration, the cam plates 31 are mounted on the pair of outer surfaces extending in the arrangement direction of the connector fitting portions 53 out of the outer peripheral surface of the female housing 11, i.e. surfaces different from the surface located between the adjacent female housings 11. Thus, the female housings 11 can be more closely arranged. Associated with this, the male housing 51 can be miniaturized in the arrangement direction of the connector fitting portions 53. Therefore, the entire connector can be miniaturized in the arrangement direction of the connector fitting portions 53.

Further, only one lever fitting portion 54 may be provided for one connector fitting portion 53 and arranged on the outer surface extending in the arrangement direction of the connector fitting portions 53 out of the outer peripheral surface of the connector fitting portion 53. According to such a configuration, since no lever fitting portion 54 is arranged between adjacent connector fitting portions 53, the adjacent connector fitting portions 53 can be more closely arranged and the male housing 51 can be miniaturized in the arrangement direction of the connector fitting portions 53.

Further, the cam plate fitting portion 58 to be fitted to the peripheral edge part of the cam plate 31 between the initial position and the connection position may be provided on the outer surface opposite to the lever fitting portion 54 out of the outer peripheral surface of the connector fitting portion 53. According to such a configuration, the detachment of the cam plate 31 from the female housing 11 can be prevented in rotating the lever 30 by fitting the peripheral edge part of the cam plate 31 into the cam plate fitting portion 58.

For each of the pair of female housings 11 located on the opposite ends in the arrangement direction out of the plurality of female housings 11, the operating portion 32 may be arranged on the side edge opposite to the adjacent female housing 11 when the lever 30 is at the connection position. According to such a configuration, the adjacent female housings 11 can be more closely arranged since the operating portion 32 of the lever 30 is not arranged between the adjacent female housings 11.

Further, at the initial position, the wires drawn out from the female housing 11 may not be bent in a direction different from the draw-out direction of the wires by the operating portion 32. According to such a configuration, it can be avoided that the wires are bent by the operating portion 32 when the lever 30 is at the initial position.

Conventionally, a lever-type connector in which both male and female connectors are connected and separated by rotating a lever is, for example, known from Japanese Unexamined Patent Publication No. 2013-20904. This is configured such that the lever rotatable between an initial position and a connection position is assembled with a male housing and formed with a locking piece and the male housing, on which the lever is to be mounted, is formed with a locking hole. A locking portion to be fitted into the locking hole for locking is formed on a tip part of the locking piece. When the lever is assembled with the male housing, the locking portion of the locking piece is locked to the locking hole of the male housing, whereby the lever is held at the initial position.

However, in the above lever-type connector, the locking piece may be twisted and broken if the lever at the initial position is strongly pushed toward the connection position. Thus, the locking piece is disengaged from the locking hole to permit the rotation of the lever. A second embodiment of the present invention was completed on the basis of the above situation and aims to improve a lever holding force at an initial position by preventing the breakage of a locking piece even if a lever at the initial position is strongly pushed toward a connection position.

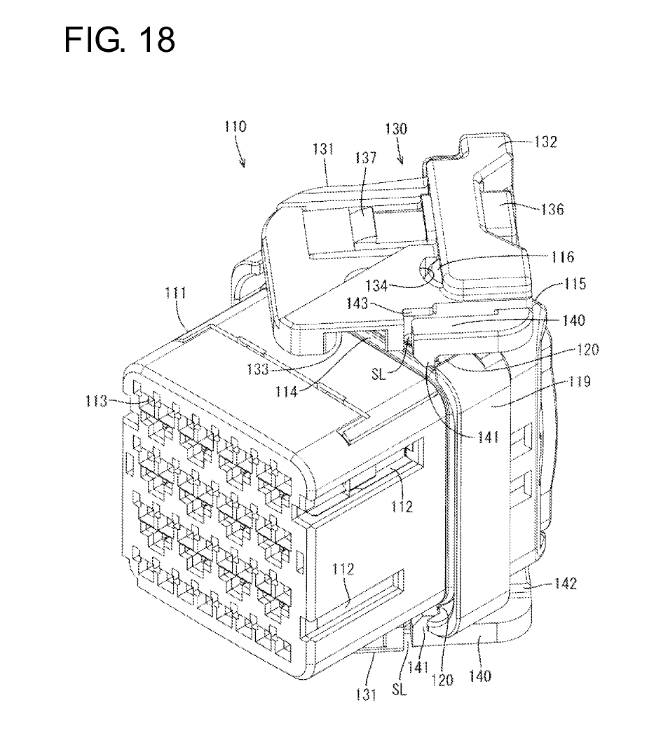

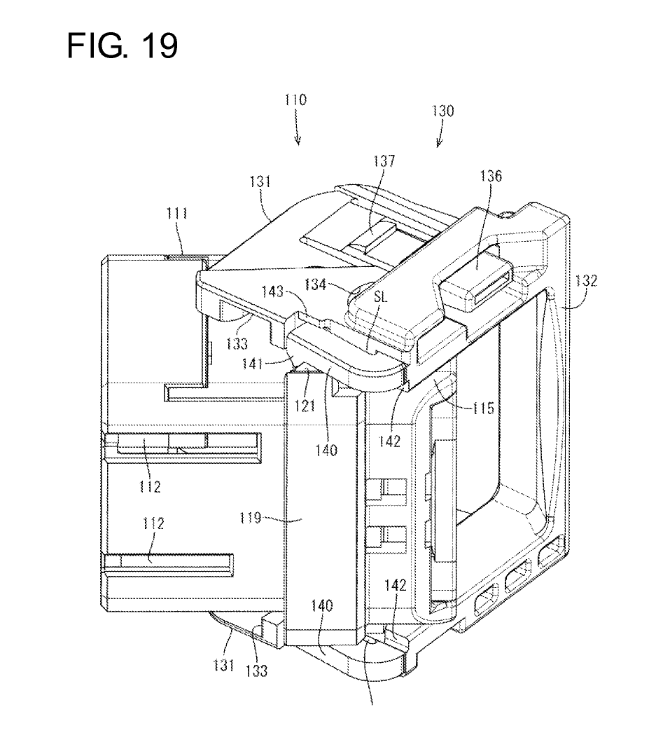

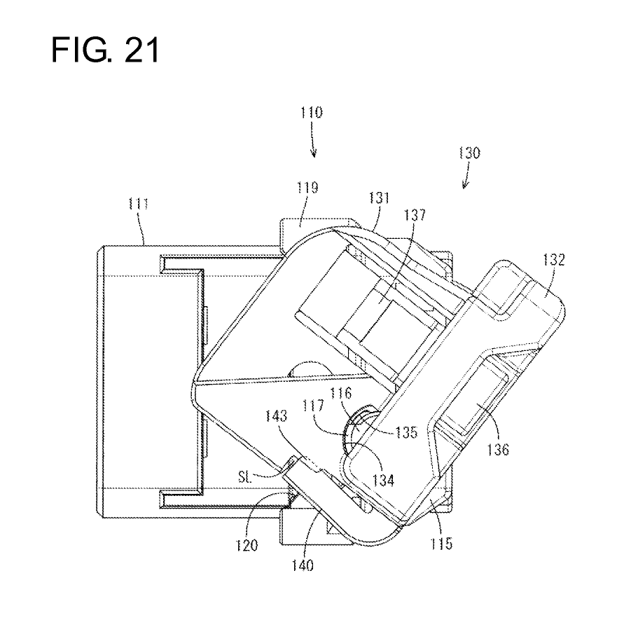

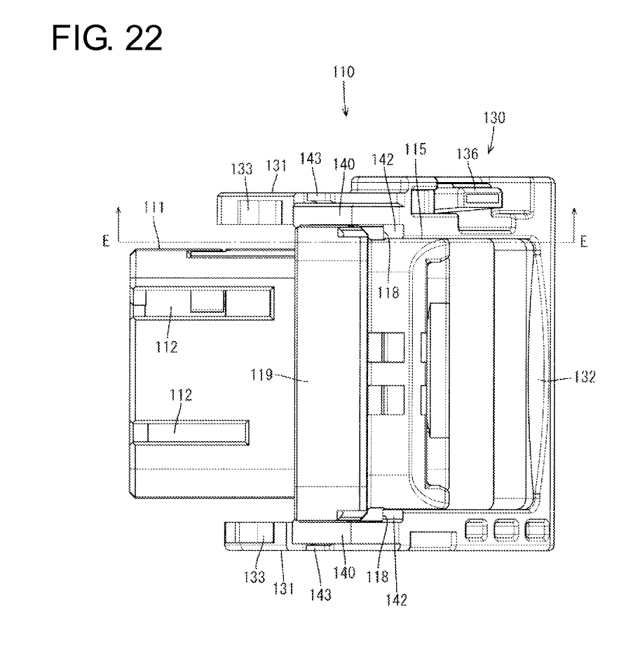

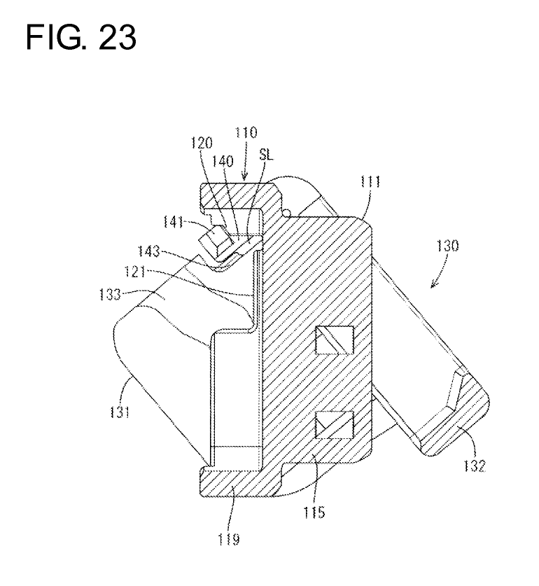

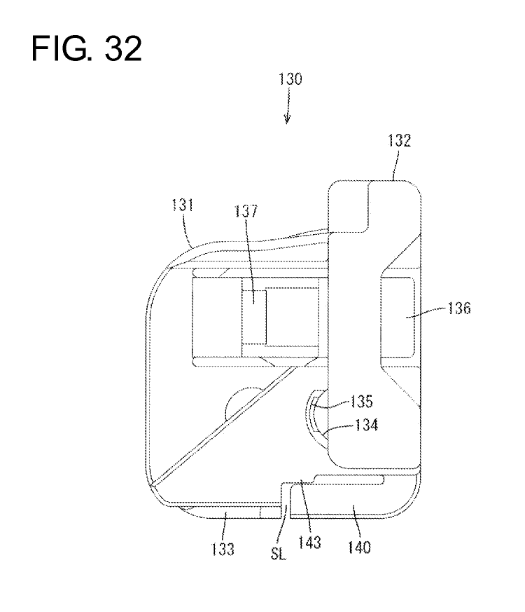

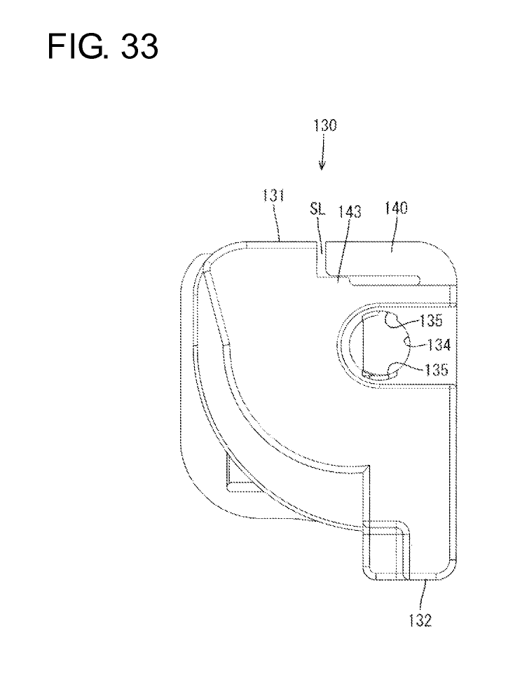

This embodiment is described with reference to FIGS. 18 to 34. A lever-type connector 2 in this embodiment includes a plurality of female connectors 110 and a male connector 150 to which these female connectors 110 are connectable similarly to the lever-type connector 1 of the first embodiment. A lever 130 is rotatably mounted on each female connector 110, and each female connector 110 is individually connectable to and separable from the male connector 150 by rotating this lever 130. In the following description, a connecting direction of the female connectors 110 to the male connector 150 is referred to as a front-back direction and connection surface sides of the female connectors 110 and the male connector 150 are referred to as front sides.

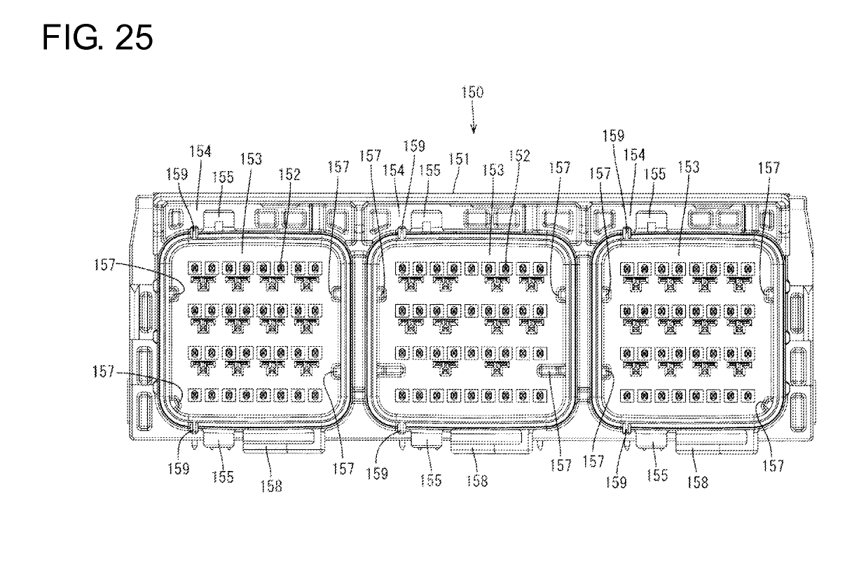

First, the configuration of the male connector 150 is described. As shown in FIG. 25, the male connector 150 includes a male housing 151 made of synthetic resin and long in a width direction and a plurality of male terminals 152 held in this male housing 151. The male terminal 152 is formed by bending a square wire made of an electrically conductive metal into an L shape. On the other hand, the male housing 151 is made of synthetic resin and includes a plurality of connector fitting portions 153 into which the female connectors 110 are fittable. Any of the plurality of connector fitting portions 153 is open forward and the connector fitting portions 153 are arranged side by side in the width direction.

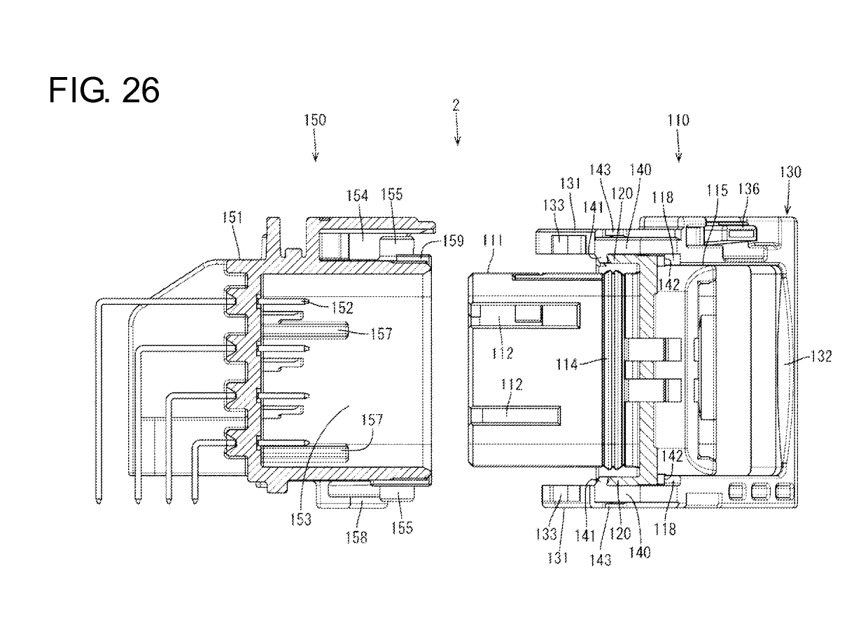

As shown in FIG. 26, one end of the male terminal 152 projects forward from the back wall of the connector fitting portion 153 and the other end thereof is bent at a right angle to extend downward after extending backward through the back wall of the connector fitting portion 153. Specifically, the male connector 150 is a board connector to be mounted on a circuit board (not shown) and the other ends of the male terminals 152 are inserted into through holes (not shown) formed on the circuit board and soldered.

As shown in FIG. 25, lever fitting portions 154 into which the levers 130 are fittable are arranged on the upper surfaces (surfaces extending along an arrangement direction of the connector fitting portions 153) of the connector fitting portions 153. The lever fitting portions 154 are open forward and a plurality of lever fitting portions 154 are provided to correspond to the respective connector fitting portions 153. A cam pin 155 is formed to project upward on the lower surface in the lever fitting portion 154 (upper surface of the connector fitting portion 153). Further, a cam pin 155 is formed to project downward also on the lower surface of the connector fitting portion 153. A pair of upper and lower cam pins 155 are coaxially arranged.

An unillustrated lock hole is formed to be open on the upper surface in the lever fitting portion 154. This lock hole is arranged on an opening edge part of the lever fitting portion 154 and the cam pin 155 is arranged somewhat at the back side of (behind) this lock hole. Further, a releasing rib 159 is formed laterally to the cam pin 155 in the lever fitting portion 154. As shown in FIG. 26, this releasing rib 159 is in the form of a rib arranged on the lower surface in the lever fitting portion 154 and extending backward from the opening edge part of the lever fitting portion 154.

As shown in FIG. 25, a plurality of guide projections 157 in the form of elongated projections are provided on opposite side surfaces in the connector fitting portion 153. As shown in FIG. 26, the guide projections 157 are formed to extend forward from the back wall of the connector fitting portion 153. On the other hand, a plurality of guide recesses 112 into which the respective guide projections 157 are fittable are formed on opposite side surfaces of the female connector 110. When the female connector 110 is fitted into the connector fitting portion 153 each guide projection 157 is fitted into each guide recess 112, thereby preventing erroneous connection of the female connector 110 and the male connector 150, guiding a connecting operation and enabling the connecting operation to be smoothly performed.

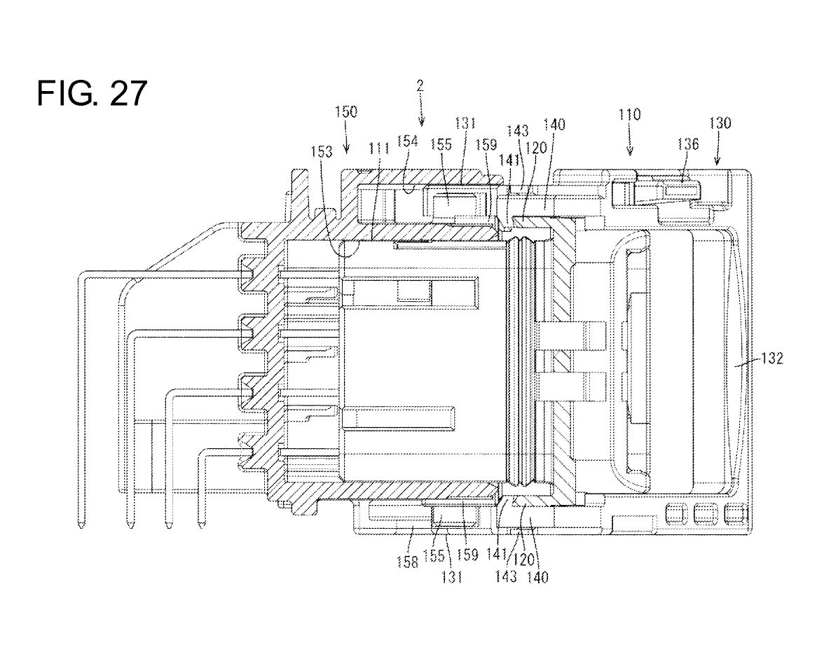

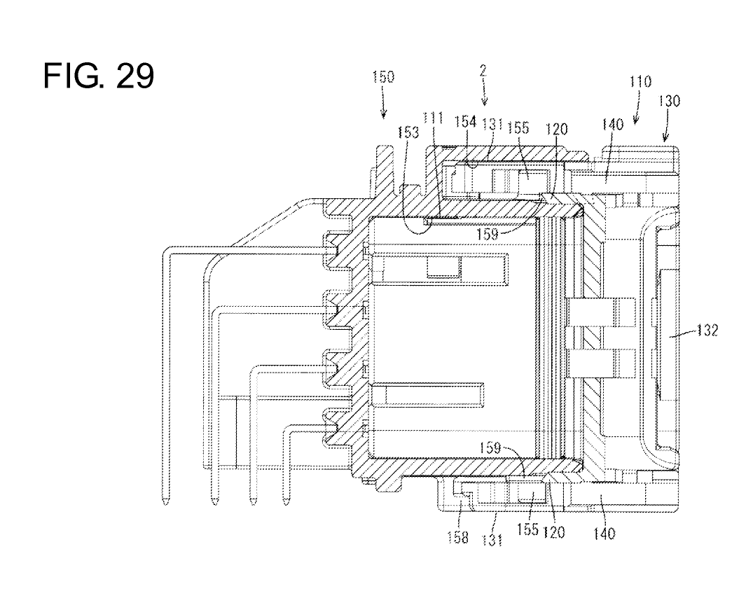

As shown in FIG. 25, cam plate fitting portions 158 into which peripheral edge parts of cam plates 131 to be described later are fittable are provided on the lower surface of the male housing 151. When the female connector 110 and the male connector 150 are lightly connected, the peripheral edge part of the cam plate 131 is fitted into this cam plate fitting portion 158 and a state of the cam plate fitting portion 158 fitted to the peripheral edge part of the cam plate 131 is maintained between an initial position (position of the lever 130 in FIG. 27) and a connection position (position of the lever 130 in FIG. 29). In this way, it can be avoided that the cam plate 131 is separated from the male housing 151 and the lever 130 is opened and deformed.

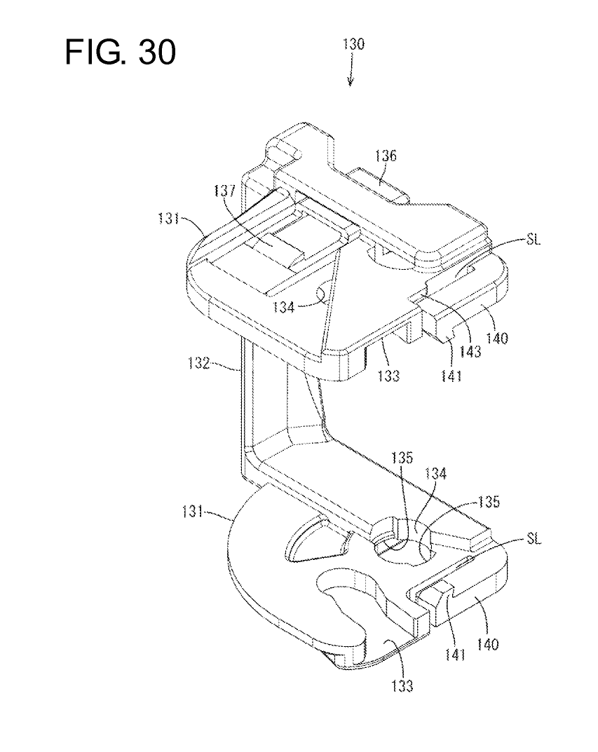

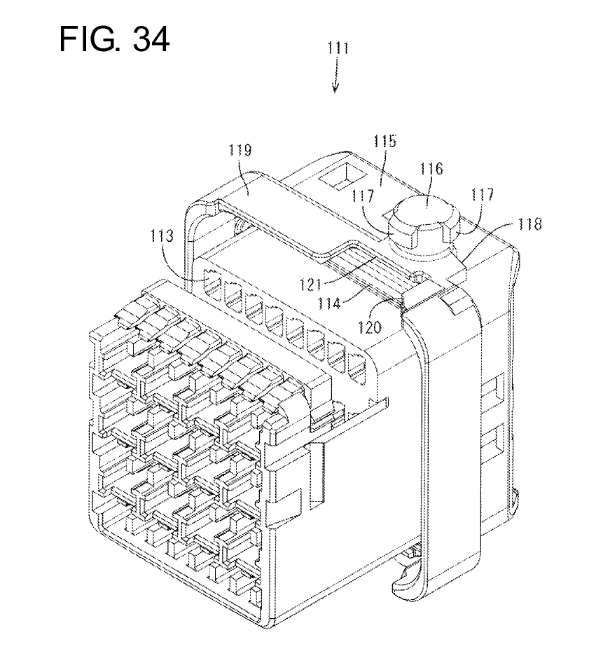

Next, the configuration of the female connector 110 is described. The female connector 110 is formed by assembling the lever 130 shown in FIG. 30 with a female housing 111 shown in FIG. 34. The female housing 111 is made of synthetic resin and substantially in the form of a rectangular block. Cavities 113 penetrating in the front-back direction are formed in the female housing 111. Unillustrated female terminals can be accommodated into the cavities 113 and the male terminals 152 are fitted and connected to the female terminals as the female connector 110 and the male connector 150 are connected.

As shown in FIG. 26, a seal ring 114 having a substantially rectangular shape is fitted on the outer peripheral surface of the female housing 111. When the female connector 110 and the male connector 150 are connected, the seal ring 114 is sandwiched between the outer peripheral surface of the female housing 111 and the inner peripheral surface of the connector fitting portion 153 as shown in FIG. 29. In this way, the interior of the connector fitting portion 153 is held in a sealed state.

Further, a receptacle 119 covering the seal ring 114 is circumferentially provided on the outer peripheral surface of the female housing 111 as shown in FIG. 34. This receptacle 119 is formed to be open forward. When the female connector 110 and the male connector 150 are connected, the receptacle 119 is fitted on an outer peripheral side of the opening edge part of the connector fitting portion 153. In this way, the receptacle 119 is arranged to avoid interference with the connector fitting portion 153 while protecting the seal ring 114.

Further, a lever mounting portion 115 on which the lever 130 is to be mounted is formed behind the receptacle 119 on the female housing 111. A supporting shaft 116 projects on each of upper and lower surfaces (surfaces extending in an arrangement direction of the plurality of female connectors 110) of the lever mounting portion 115. A pair of holding projections 117 are formed to bulge out on a projecting end of the supporting shaft 116.

As shown in FIG. 30, the lever 130 is configured into a substantially gate shape by including a pair of cam plates 131 each formed with a cam groove 133 and an operating portion 132 coupling these cam plates 131. The cam plate 131 is formed with a shaft hole 134, into which the supporting shaft 116 of the female housing 111 is fittable and which penetrates in a plate thickness direction. The shaft hole 134 is configured as a stepped round hole having a larger diameter on an upper side and a pair of mounting grooves 135, through which the holding projections 117 of the supporting shaft 116 are insertable, are respectively formed on opposite radial end parts of the shaft hole 134. In assembling the lever 130 with the female housing 111, the lever 130 is slightly rotated after the supporting shafts 116 are fitted into the shaft holes 134 by passing each holding projection 117 through each mounting groove 135. In this way, each holding projection 117 is locked to a hole edge part of each shaft hole 134 in an axial direction to prevent the opening of the lever 130 and rotatably support the lever 130.

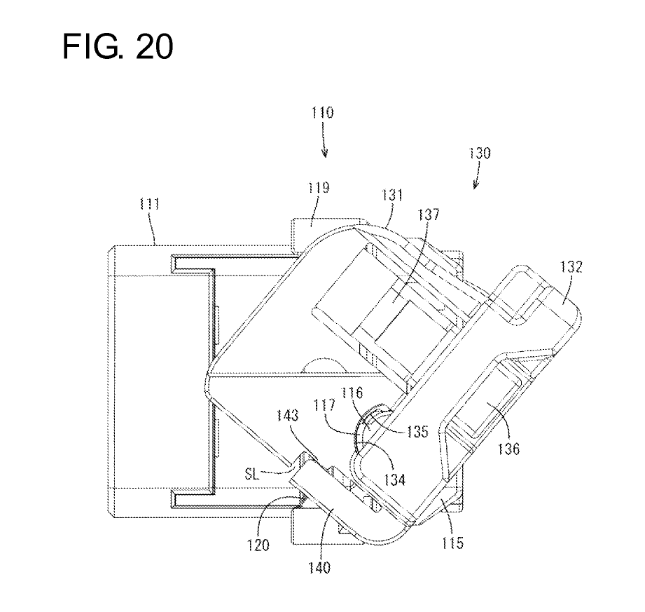

The lever 130 is rotatable between the initial position and the connection position. The initial position is the position of the lever 130 shown in FIG. 20 and a position where wires (not shown) drawn out backward from the female housing 111 are not bent in a direction different from a draw-out direction of the wires by the operating portion 132. Thus, the wires drawn out backward from the female housing 111 are directly guided to a rear side without being laterally bent by the operating portion 132.

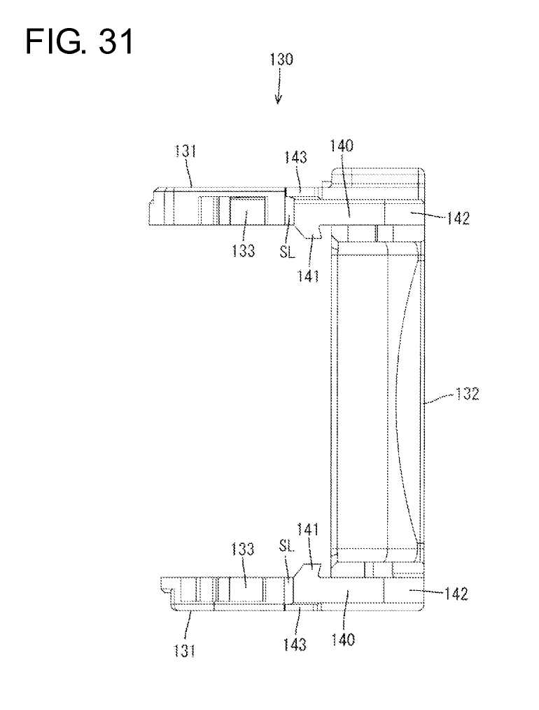

As shown in FIG. 34, regulation projections 118 are formed to bulge out backward on the rear edge of the receptacle 119. These regulation projections 118 are coupled to the cam pins 155. As shown in FIG. 31, regulation projection receiving portions 142 lockable to the regulation projections 118 of the receptacle 119 are formed on the peripheral edges of the cam plates 131. These regulation projection receiving portions 142 are locked to the regulation projections 118 at the initial position, thereby suppressing backward (direction opposite to that toward the connection position) rotation of the lever 130 beyond the initial position.

At the initial position, the entrances of the cam grooves 133 are facing forward and the cam pins 155 can be guided into the cam grooves 133 through the entrances as shown in FIG. 18. The cam groove 133 is linearly formed to approach the shaft hole 134 from the outer edge of the cam plate 131 as shown in FIG. 30. Thus, when the lever 130 is rotated from the initial position toward the connection position, the cam pins 155 move along the cam grooves 133 and the female connector 110 and the male connector 150 are pulled toward each other by a cam action based on the engagement of these. When the lever 130 reaches the connection position, the cam pins 155 reach the back ends of the cam grooves 133 and the female connector 110 and the male connector 150 are properly connected.

When the lever 130 is at the connection position as shown in FIG. 29, the rear end position of the lever 130 is substantially aligned with that of the female housing 111 and the rear surface of the lever 130 constitutes a part of the rear surface of the female connector 110. Further, the cam plates 131 are arranged proximately to the upper and lower surfaces of the lever mounting portion 115.

As shown in FIG. 30, the upper cam plate 131 is formed with a lock arm 136. This lock arm 136 is in the form of a cantilever and formed to be deflectable in a plate thickness direction of the cam plate 131. A locking portion 137 is formed on a longitudinal central part of the lock arm 136. This locking portion 137 is locked to a lock hole (not shown) of the lever fitting portion 15 in a connecting direction by connecting the female connector 110 and the male connector 150. In this way, the lever 130 is held at the connection position.

The lever 130 of this embodiment is provided with locking pieces 140 for holding the lever 130 to prevent the rotation from the initial position to the connection position. As shown in FIG. 30, the locking piece 140 is in the form of a cantilever extending along a side edge part of the cam plate 131. Specifically, the cantilever-shaped locking piece 140 is formed by providing an L-shaped slit from a tip side of the locking piece 140 toward a base end side on a side of the side edge part of the cam plate 131 opposite to the operating portion 132.

A locking projection 141 is formed on a tip part of the locking piece 140. As shown in FIG. 31, this locking projection 141 extends toward the base end side while projecting inwardly (toward the locking piece 140 located on an opposite side) from the tip part of the locking piece 140. That is, a locking surface of the locking projection 141 is formed to be at an acute angle to the locking piece 140.

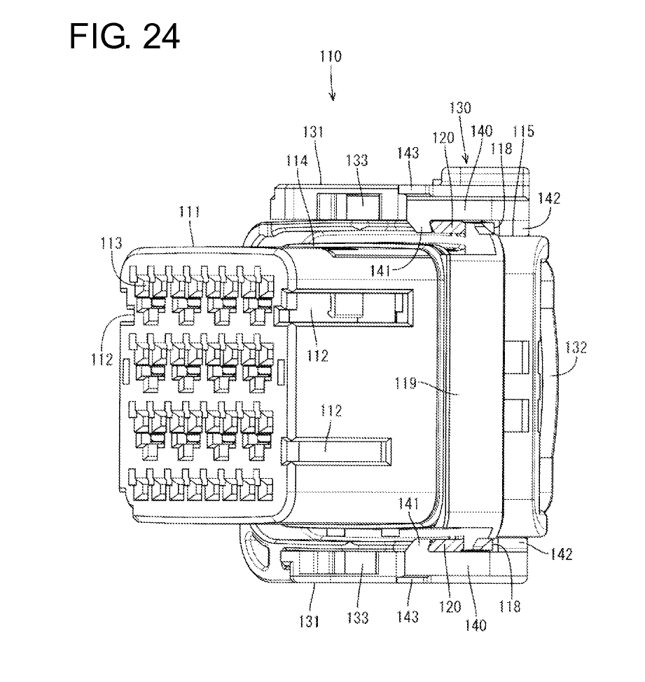

On the other hand, the receptacle 119 of the female housing 111 is formed with locking piece receiving portions 120 as shown in FIG. 34. These locking piece receiving portions 120 are formed by cutting the opening edge of the receptacle 119. Specifically, the opening edge of the receptacle 119 is recessed to form a cut portion 121 for allowing the cam pin 155 to escape as the female connector 110 and the male connector 150 are connected, and the locking piece receiving portion 120 is formed on one of a pair of facing edges constituting this cut portion 121. The locking piece receiving portion 120 is formed to extend in a direction oblique to the connecting direction of the female connector 110 and the male connector 150 and has a locked surface substantially extending along the locking surface of the locking projection 141 as shown in FIG. 24. Thus, when the lever 130 at the initial position is pushed to the connection position, the locking surfaces of the locking projections 141 and the locked surfaces of the locking piece receiving portions 120 are locked, whereby the lever 130 is firmly held at the initial position and the locking pieces 140 are not easily lifted.

However, if a lever at an initial position is pushed toward a connection position with a very strong force, a locking piece may be broken or a locked state of a locking surface of the locking piece and a locked surface of a locking piece receiving portion may be released to lift the locking piece, whereby the rotation of the lever may be permitted. Accordingly, in this embodiment, lift preventing portions 143 are provided to prevent the lift of the locking pieces 140.

As shown in FIG. 30, the lift preventing portion 143 is formed to bulge out from the side of the cam plate 131 toward the side of the locking piece 140 in a clearance SL formed between the locking piece 140 and the cam plate 131. Further, as shown in FIG. 31, the lift preventing portions 143 are arranged at outer sides of the locking pieces 140 (at upper and lower sides of a pair of locking pieces 140). Thus, if the locking piece 140 is deflected and deformed toward the cam plate 131, the locking piece 140 and the lift preventing portion 143 do not interfere with each other.

In a natural state shown in FIG. 20, the locking piece 140 is arranged not to overlap the lift preventing portion 143 in a vertical direction. However, if the locking piece 140 is deflected and deformed in a direction along the upper and lower surfaces of the cam plate 131 (direction perpendicular to the plate thickness direction of the cam plate 131) as the lever 130 is forcibly pushed, the locking piece 140 is pushed toward the cam plate 131 to slip under the lift preventing portion 143, whereby the locking piece 140 and the lift preventing portion 143 are arranged to overlap in the vertical direction. Thus, even if the locking piece 140 is going to be lifted outwardly, it comes into contact with the lift preventing portion 143, whereby the lift of the locking piece 140 is prevented and the lever 130 is held at the initial position. Therefore, it is possible to improve a force for holding the lever 130 at the initial position while preventing the breakage of the locking piece 140.

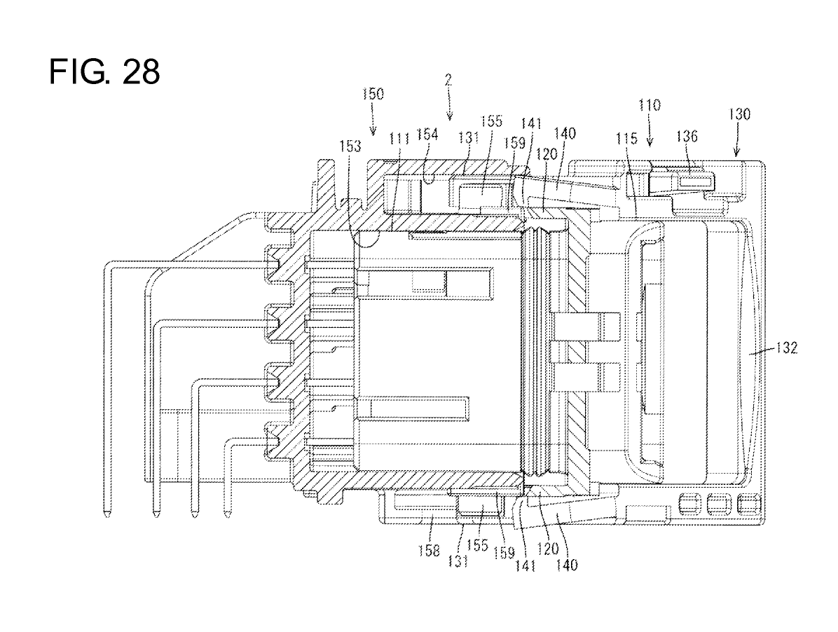

The second embodiment is configured as described above. Next, functions of this embodiment are described. To connect the female connector 110 and the male connector 150 from a pre-connection state shown in FIG. 26, the female housing 111 is lightly fitted into the connector fitting portion 153 with the lever 130 located at the initial position as shown in FIG. 27. As the connecting operation further proceeds, the locking projections 141 of the locking pieces 140 are deflected and deformed in the plate thickness direction of the cam plates 131 without interfering with the lift preventing portions 143 and move onto the releasing ribs 159 in the lever fitting portion 154 as shown in FIG. 28, whereby the locked state of the locking projections 141 of the locking pieces 140 and the locking piece receiving portions 120 is released. Thus, the rotation of the lever 130 from the initial position toward the connection position is permitted.

On the other hand, the cam pins 155 enter the entrances of the cam grooves 133 and the lever 130 is rotated from the initial position to the connection position by pushing the operating portion 132 forward. Then, the cam pins 155 and the inner walls of the cam grooves 133 are engaged with each other and the female connector 110 and the male connector 150 are pulled toward each other. During this time, the locking pieces 140 remain deflected and deformed in the plate thickness direction of the cam plates 131 and the locking projections 141 having moved onto the releasing ribs 159 move over to the locking piece receiving portions 120. When the locking projections 141 move beyond these locking piece receiving portions 120, the locking pieces 140 resiliently return as shown in FIG. 29. Further, the locking portion 137 of the lock arm 136 is engaged with the opening edge part of the lever fitting portion 154, whereby the lock arm 136 is deflected and deformed. When the locking portion 137 passes over the lock hole (not shown), the lock arm 136 resiliently returns. In this way, the locking portion 137 and the lock hole (not shown) are locked to hold the lever 130 at the connection position.

As described above, in this second embodiment, the lever 130 may include the locking pieces 140 for suppressing the rotation of the lever 130 from the initial position to the connection position and the lift preventing portions 143 for preventing the lift of these locking pieces 140, the female housing 111 may include the locking piece receiving portions 120 for holding the lever 130 at the initial position by being locked to the locking pieces 140, and the locking pieces 140 may be prevented from being lifted and the locked state thereof to the locking piece receiving portions 120 may be maintained by the locking pieces 140 being deflected and deformed and arranged to overlap the lift preventing portions 143 with the locked state to the locking piece receiving portions 120 maintained when the lever 130 is pushed from the initial position to the connection position.

Normally, when a lever at an initial position is pushed to a connection position, a locking piece is locked to a locking piece receiving portion to hold the lever at the initial position. However, if the lever is pushed with a stronger force, a locked state of the locking piece and the locking piece receiving portion may be released to permit the rotation of the lever. In that respect, according to the above configuration, the locking pieces 140 are arranged to overlap the lift preventing portions 143 upon being deflected and deformed and the lift of the locking pieces 140 is prevented by the lift preventing portions 143. Thus, the locked state of the locking pieces 140 and the locking piece receiving portions 120 is maintained and the rotation of the lever 130 at the initial position to the connection position can be reliably suppressed.

The lever 130 may be configured into a substantially gate shape by including the pair of cam plates 131 each formed with the cam groove 133 and the operating portion 132 coupling these cam plates 131, and the locking pieces 140 may be formed in a cantilever manner along the side edge parts of the cam plates 131. According to such a configuration, the locking pieces 140 can be arranged at positions as distant from a center of rotation of the lever 130 as possible. Thus, when the lever 130 is pushed, forces applied to locked parts of the locking pieces 140 and the locking piece receiving portions 120 can be reduced and the locking pieces 140 are more easily deflected and deformed with the locked state of the locking pieces 140 and the locking piece receiving portions 120 maintained.

The female housing 111 may include the seal ring 114 fitted on the outer peripheral surface and the receptacle 119 formed to cover this seal ring 114 and be open forward and the locking piece receiving portions 120 may be formed by cutting the opening edge of the receptacle 119. According to such a configuration, the locking piece receiving portions 120 can be formed on the receptacle 119 and need not be provided separately from the receptacle 119.

The present invention is not limited to the above described and illustrated embodiments. For example, the following embodiments are also included in the technical scope of the present invention.

Although the substantially gate-shaped lever 30, 130 including the pair of cam plates 31, 131 is illustrated in the above first and second embodiments, a lever may include only one cam plate according to the present invention.

Although the plurality of connector fitting portions 53, 153 are arranged side by side in the above first and second embodiments, a male housing may include only one connector fitting portion according to the present invention.

Although the lever 30, 130 is laterally rotatable by mounting the pair of cam plates 31, 131 on the opposite upper and lower surfaces of the lever mounting portion 15, 115 in the above first and second embodiments, a lever may be vertically rotatable according to the present invention.

Although the operating portions 32 of the female connectors 10 located at the opposite left and right ends are respectively arranged to face opposite sides at the connection position in the first embodiment, all the connector fitting portions may be arranged to face the same side at the connection position according to the present invention.

Although the operating portion 32, 132 is arranged not to interfere with the wires in the above first and second embodiments, a draw-out direction of wires may be changed by bringing an operating portion into contact with the wires according to the present invention.

Although the locking piece 140 is arranged to overlap the lift preventing portion 143 by being deflected and deformed in the direction perpendicular to the plate thickness direction of the cam plate 131 in the second embodiment, a locking piece may be arranged to overlap a lift preventing portion by being deflected and deformed in a plate thickness direction of a cam plate according to the present invention.

Although the locking piece 140 is arranged along the side edge part of the cam plate 131 in the second embodiment, a locking piece may be arranged at an inner side of a side edge part of a cam plate, for example, like the lock arm 136 according to the present invention.

Although the locking piece receiving portion 120 is formed on the opening edge of the receptacle 119 in the second embodiment, a locking piece receiving portion may be formed on a part other than the receptacle 119 (e.g. lever mounting portion 115 located behind the receptacle 119) according to the present invention.

### LIST OF REFERENCE SIGNS

11, 111 . . . female housing
30, 130 . . . lever
31, 131 . . . cam plate
32, 132 . . . operating portion
33, 133 . . . cam groove
51, 151 . . . male housing
53, 153 . . . connector fitting portion
54, 154 . . . lever fitting portion
56 . . . lock projection (lock portion)
58, 158 . . . cam plate fitting portion
114 . . . seal ring
119 . . . receptacle
120 . . . locking piece receiving portion
140 . . . locking piece
143 . . . lift preventing portion

1. A lever-type connector, comprising:
a female housing;
a lever rotatably mounted on the female housing and rotatable between an initial position and a connection position;
a male housing including a connector fitting portion into which the female housing is fittable and a lever fitting portion into which the lever is fittable, both the connector fitting portion and the lever fitting portion being open in the same direction; and
a lock portion provided in the lever fitting portion and configured to hold the lever fitted into the lever fitting portion at the connection position.

2. The lever-type connector of claim 1, wherein:
the lever is configured into a substantially gate shape by including a pair of cam plates each formed with a cam groove and an operating portion coupling the cam plates;
the male housing includes a plurality of the connector fitting portions arranged side by side; and
the pair of cam plates are respectively rotatably mounted on a pair of outer surfaces extending in an arrangement direction of the connector fitting portions out of an outer peripheral surface of the female housing.

3. The lever-type connector of claim 2, wherein only one lever fitting portion is provided for one connector fitting portion and arranged on an outer surface extending in the arrangement direction of the connector fitting portion out of an outer peripheral surface of the connector fitting portion.

4. The lever-type connector of claim 3,
wherein a cam plate fitting portion fittable to a peripheral edge part of the cam plate between the initial position and the connection position is provided on an outer surface opposite to the lever fitting portion out of the outer peripheral surface of the connector fitting portion.

5. The lever-type connector of claim 2, wherein the operating portion is arranged on a side edge opposite to the adjacent female housing when the lever is at the connection position for a pair of the female housings located at opposite ends in an arrangement direction out of a plurality of the female housings.

6. The lever-type connector of claim 5, wherein wires drawn out from the female housing are not bent in a direction different from a draw-out direction of the wires by the operating portion at the initial position.

7. The lever-type connector of claim 1, wherein:
the lever includes a locking piece configured to suppress the rotation of the lever from the initial position to the connection position and a lift preventing portion configured to prevent the locking piece from being lifted;
the female housing includes a locking piece receiving portion configured to hold the lever at the initial position by being locked to the locking piece; and
the locking piece is deflected and deformed and arranged to overlap the lift preventing portion while maintaining a locked state to the locking piece receiving portion, whereby the lift of the locking piece is prevented and the locked state to the locking piece receiving portion is maintained, when the lever is pushed from the initial position to the connection position.

8. The lever-type connector of claim 7, wherein:
the lever is configured into a substantially U shape by including a pair of cam plates each formed with a cam groove and an operating portion coupling the cam plates; and
the locking piece is formed in a cantilever manner along a side edge part of the cam plate.

9. The lever-type connector claim 7, wherein:
the female housing includes a seal ring fitted on an outer peripheral surface and a receptacle formed to cover the seal ring and be open forward; and
the locking piece receiving portion is formed by cutting an opening edge of the receptacle.
